(19) United States
(12) Patent Application Publication
(10) Pub. No.: US 2019/0381783 A1
(43) Pub. Date: Dec. 19, 2019

(54) METHOD AND APPARATUS FOR INCREASING BONDING IN MATERIAL EXTRUSION ADDITIVE MANUFACTURING

(71) Applicant: SABIC Global Technologies, B.V., Bergen op Zoom (NL)

(72) Inventors: Malvika Bihari, Evansville, IN (US); Satish Kumar Gaggar, Hoover, AL (US); Lakshmikant Suryakant Powale, Delmar, NY (US); Daniel Caleb Brooks, Houston, TX (US); Peter James Zuber, Houston, TX (US)

(21) Appl. No.: 16/542,633

(22) Filed: Aug. 16, 2019

Related U.S. Application Data
(62) Division of application No. 15/319,572, filed on Dec. 16, 2016.
(60) Provisional application No. 62/012,639, filed on Jun. 16, 2014.

(51) Int. Cl. B33Y 50/02; B33Y 10/00; B33Y 30/00

(52) U.S. Cl. CPC B33Y 50/02; B29K 2101/12; B33Y 30/00; B33Y 10/00

(57) ABSTRACT

A method of forming a three dimensional object comprising: depositing a layer of thermoplastic polymeric material in a preset pattern on a platform to form a deposited layer; directing an energy source, via an energy beam at an energy source target area on the deposited layer to increase the surface energy of the deposited layer at the energy source target area; contacting the energy source target area with a subsequent layer wherein the subsequent layer is deposited along a path of the preset pattern; wherein directing an energy source at the energy source target area comprises applying energy to the layer at an area preceding the depositing of the subsequent layer to that area; and repeating the preceding steps to form the three dimensional object.

### CROSS REFERENCE TO RELATED APPLICATIONS

This application is a divisional of U.S. patent application Ser. No. 15/319,572, filed Dec. 16, 2016, which is a 371 of International Application No. PCT/IB2015/054557, filed Jun. 16, 2015, which claims priority to U.S. Patent Application No. 62/012,639, filed Jun. 16, 2014, each of which is incorporated by reference in its entirety herein.

### BACKGROUND

Additive Manufacturing (AM) is a new production technology that is transforming the way all sorts of things are made. AM makes three-dimensional (3D) solid objects of virtually any shape from a digital model. Generally, this is achieved by creating a digital model of a desired solid object with computer-aided design (CAD) modeling software and then slicing that virtual blueprint into very small digital cross-sections. These cross-sections are formed or deposited in a sequential layering process in an AM machine to create the 3D object. AM has many advantages, including dramatically reducing the time from design to prototyping to commercial product. Running design changes are possible. Multiple parts can be built in a single assembly. No tooling is required. Minimal energy is needed to make these 3D solid objects. It also decreases the amount of waste and raw materials. AM also facilitates production of extremely complex geometrical parts. AM also reduces the parts inventory for a business since parts can be quickly made on-demand and on-site.

Material extrusion (a type of AM) can be used as a low capital forming process for producing plastic parts, and/or forming process for difficult geometries. Material Extrusion involves an extrusion-based additive manufacturing system that is used to build a three-dimensional (3D) model from a digital representation of the 3D model in a layer-by-layer manner by selectively dispensing a flowable material through a nozzle or orifice. After the material is extruded, it is then deposited as a sequence of roads on a substrate in an x-y plane. The extruded modeling material fuses to previously deposited modeling material, and solidifies upon a drop in temperature. The position of the extrusion head relative to the substrate is then incremented along a z-axis (perpendicular to the x-y plane), and the process is then repeated to form a 3D model resembling the digital representation.

Material extrusion parts can be used as prototype models to review geometry. Part strength and appearance are secondary to overall design concept communication as improved aesthetic properties have been achieved by post process finishing steps such as coating or sanding. However, the strength of the parts in the build direction is limited by the bond strength and effective bonding surface area between subsequent layers of the build. These factors are limited for two reasons. First, each layer is a separate melt stream. Thus, the polymer chains of a new layer were not allowed to comingle with those of the antecedent layer. Secondly, because the previous layer has cooled, it must rely on conduction of heat from the new layer and any inherent cohesive properties of the material for bonding to occur. The reduced adhesion between layers also results in a highly stratified surface finish.

Accordingly, a need exists for enhanced for an AM process capable of producing parts with improved aesthetic qualities and structural properties.

### BRIEF DESCRIPTION

The above described and other features are exemplified by the following figures and detailed description.

A method of forming a three dimensional object comprising: depositing a layer of thermoplastic polymeric material in a preset pattern on a platform to form a deposited layer; directing an energy source, via an energy beam at an energy source target area on the deposited layer to increase the surface energy of the deposited layer at the energy source target area; contacting the energy source target area with a subsequent layer wherein the subsequent layer is deposited along a path of the preset pattern; wherein directing an energy source at the energy source target area comprises applying energy to the layer at an area preceding the depositing of the subsequent layer to that area; and repeating the preceding steps to form the three dimensional object.

An apparatus for forming a three dimensional object comprising: a platform configured to support the three-dimensional object; an extrusion head arranged relative to the platform and configured to deposit a thermoplastic material in a preset pattern to form a layer of the three-dimensional object; an energy source disposed relative to the extrusion head and configured to increase the surface energy of an energy source target area; wherein the energy source target area comprises a portion of a deposited layer preceding the area for the depositing of a subsequent layer; a controller configured to control the position of the extrusion head and the energy source relative to the platform.

A method of forming a three dimensional object comprising: depositing a layer of thermoplastic polymeric material using a fused deposition modeling apparatus in a preset pattern on a platform; increasing the surface energy of at least a portion of the layer; depositing a subsequent layer onto the layer; repeating the preceding steps to form the three dimensional object.

### BRIEF DESCRIPTION OF THE DRAWINGS

Refer now to the figures, which are exemplary embodiments, and wherein the like elements are numbered alike and which are presented for the purposes of illustrating the exemplary embodiments disclosed herein and not for the purposes of limiting the same.

FIG. 1 is a front view of an exemplary extrusion-based additive manufacturing system.

FIG. 2 is a front view of an extrusion head depositing layers of thermoplastic material without an energy source.

FIG. 3 is a front view of an extrusion head depositing layers of thermoplastic material with an energy source.

FIG. 4 is a side view of layers of thermoplastic material deposited to form a three dimensional object.

FIG. 5 is a top view of layers of thermoplastic material deposited to form a three dimensional object.

FIG. 6 is a flow diagram of an exemplary process for forming a three dimensional object.

FIG. 7 is a flow diagram of an exemplary process for forming a three dimensional object.

FIG. 8 is a front view of an extrusion head depositing layers of thermoplastic material with an energy source, pressure source, and temperature sensor.

### DETAILED DESCRIPTION

Disclosed herein are additive manufacturing modeling methods and apparatus capable of producing parts with increased bonding between adjacent layers. Without being bound by theory, it is believed that the favorable results obtained herein, e.g., high strength three dimensional polymeric components, can be achieved through increasing the surface energy of a portion of a deposited layer prior to depositing a subsequent layer onto and/or adjacent to the portion. Due to the higher surface energy of the deposited layer and improved adhesion, the surface contact area between the layers can also be increased, thereby improving strength in the build direction and/or laterally between adjacent layers. In addition, an increase bonding between layers can overcome some surface tension between layers resulting in cohesion which can enable improved surface quality of parts. Accordingly, parts with superior mechanical and aesthetic properties can be manufactured.

The term “material extrusion additive manufacturing technique” as used in the present specification and claims means that the article of manufacture can be made by any additive manufacturing technique that makes a three-dimensional solid object of any shape by laying down material in layers from a thermoplastic material such as a monofilament or pellet from a digital model by selectively dispensing through a nozzle or orifice. For example, the extruded material can be made by laying down a plastic filament that is unwound from a coil or is deposited from an extrusion head. These monofilament additive manufacturing techniques include fused deposition modeling and fused filament fabrication as well as other material extrusion technologies as defined by ASTM F2792-12a.

The terms “Fused Deposition Modeling” or “Fused Filament Fabrication” involves building a part or article layer-by-layer by heating thermoplastic material to a semi-liquid state and extruding it according to computer-controlled paths. Fused Deposition Modeling utilizes a modeling material and a support material. The modeling material includes the finished piece, and the support material includes scaffolding that can be mechanically removed, washed away or dissolved when the process is complete. The process involves depositing material to complete each layer before the base moves down the Z-axis and the next layer begins.

The material extrusion extruded material can be made from thermoplastic materials. Such materials can include polycarbonate (PC), acrylonitrile butadiene styrene (ABS), acrylic rubber, ethylene-vinyl acetate (EVA), ethylene vinyl alcohol (EVOH), liquid crystal polymer (LCP), methacrylate styrene butadiene (MBS), polyacetal (POM or acetal), polyacrylate and polymethacrylate (also known collectively as acrylics), polyacrylonitrile (PAN), polyamide (PA, also known as nylon), polyamide-imide (PAI), polyaryletherketone (PAEK), polybutadiene (PBD), polybutylene (PB), polyesters such as polybutylene terephthalate (PBT), polycaprolactone (PCL), polyethylene terephthalate (PET), polycyclohexylene dimethylene terephthalate (PCT), and polyhydroxyalkanoates (PHAs), polyketone (PK), polyolefins such as polyethylene (PE) and polypropylene (PP), fluorinated polyolefins such as polytetrafluoroethylene (PTFE) polyetheretherketone (PEEK), polyetherketoneketone (PEKK), polyetherimide (PEI), polyethersulfone (PES), polysulfone, polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyphenylsulfone, polytrimethylene terephthalate (PTT), polyurethane (PU), styrene-acrylonitrile (SAN), or any combination comprising at least one of the foregoing. Polycarbonate blends with ABS, SAN, PBT, PET, PCT, PEI, PTFE, or combinations comprising at least one of the foregoing are of particular note to attain the balance of the desirable properties such as melt flow, impact and chemical resistance. The amount of these other thermoplastic materials can be from 0.1% to 70 wt. %, in other instances, from 1.0% to 50 wt. %, and in yet other instances, from 5% to 30 wt. %, based on the weight of the monofilament.

The term “polycarbonate” as used herein means a polymer or copolymer having repeating structural carbonate units of formula (1)

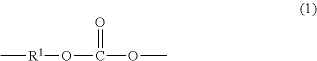

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

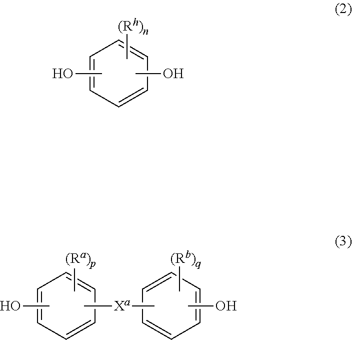

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl; and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further include heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of specific dihydroxy compounds include the following: bisphenol compounds such as 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”, in which in which each of A¹ and A² is p-phenylene and X^{a} is isopropylidene in formula (3)), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane (DMBPC), and 1,1-bis(4-hydroxy-3-methylphenyl)-3,3,5-trimethylcyclohexane (isophorone bisphenol).

These aromatic polycarbonates can be manufactured by known processes, for example, by reacting a dihydric phenol with a carbonate precursor, such as phosgene, in accordance with methods set forth in the above-cited literature and in U.S. Pat. No. 4,123,436, or by transesterification processes such as are disclosed in U.S. Pat. No. 3,153,008, as well as other processes known to those skilled in the art.

It is also possible to employ two or more different dihydric phenols in the event a carbonate copolymer or interpolymer rather than a homopolymer is desired. The polycarbonate copolymers can further comprise non-carbonate repeating units, for example repeating ester units (polyester-carbonates), repeating siloxane units (polycarbonate-siloxanes), or both ester units and siloxane units (polycarbonate-ester-siloxanes). Branched polycarbonates are also useful, such as are described in U.S. Pat. No. 4,001,184. Also, there can be utilized combinations of linear polycarbonate and a branched polycarbonate. Moreover, combinations of any of the above materials may be used.

In any event, the preferred aromatic polycarbonate is a homopolymer, e.g., a homopolymer derived from 2,2-bis(4-hydroxyphenyl)propane (bisphenol-A) and a carbonate or carbonate precursor, commercially available under the trade designation LEXAN Registered TM from SABIC.

The thermoplastic polycarbonates used herein possess a certain combination of chemical and physical properties. They are made from at least 50 mole % bisphenol A, and have a weight-average molecular weight (Mw) of 10,000 to 50,000 grams per mole (g/mol) measured by gel permeation chromatography (GPC) calibrated on polycarbonate standards, and have a glass transition temperature (Tg) from 130 to 180 degrees C. (° C.).

Besides this combination of physical properties, these thermoplastic polycarbonate compositions may also possess certain optional physical properties. These other physical properties include having a tensile strength at yield of greater than 5,000 pounds per square inch (psi), and a flex modulus at 100° C. greater than 1,000 psi (as measured on 3.2 mm bars by dynamic mechanical analysis (DMA) as per ASTM D4065-01).

Other ingredients can also be added to the monofilaments. These include colorants such as solvent violet 36, pigment blue 60, pigment blue 15:1, pigment blue 15.4, carbon black, titanium dioxide or any combination comprising at least one of the foregoing.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

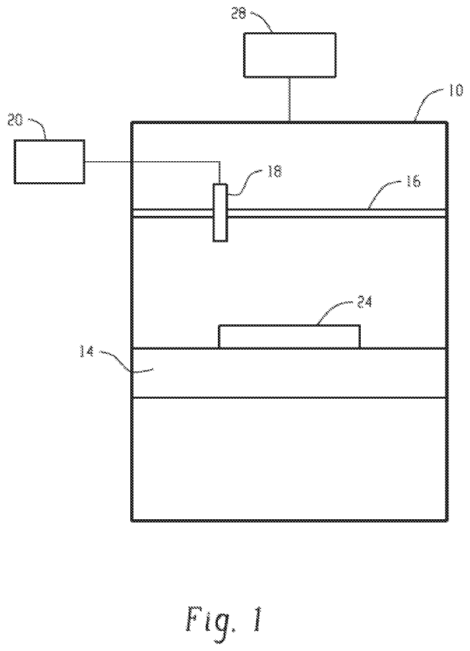

As shown in FIG. 1, system 10 is an exemplary material extrusion additive manufacturing, and includes build platform 14, guide rail system 16, extrusion head 18, and supply source 20. Build platform 14 is a support structure on which article 24 can be built, and can move vertically based on signals provided from computer-operated controller 28. Guide rail system 16 can move extrusion head 18 to any point in a plane parallel to build platform 14 based on signals provided from controller 28. In the alternative, build platform 14 can be configured to move in the horizontally, and extrusion head 18 may be configured to move vertically. Other similar arrangements may also be used such that one or both of platform 14 and extrusion head 18 are moveable relative to each other.

Energy source 54 can be coupled to extrusion head 18 or separate from extrusion head 18. For example, as shown in FIG. 3, energy source 54 is coupled to extrusion head 18 via support arm 58. In the alternative, energy source 54 can be coupled to an internal surface of system 10 or coupled to a movable support structure. Energy source 54 can be movable and controlled by computer-operated controller 28. For example, energy source 54 can be movable to provide energy to a specific point within system 10. A plurality of energy sources 54 can be employed. Energy source can include any device capable of heating an area 56 of the top portion 51 of previously deposited layer 50 to between the glass transition temperature (Tg) of the thermoplastic polymeric material exiting the extrusion head 18 (Y) and the melting temperature of the thermoplastic polymeric material; or any device capable of heating an area 56 of the top portion 51 of previously deposited layer 50 to a temperature (X) that is Y≥X≥Y−20, specifically Y≥X≥Y−10, or Y−5≥X≥Y−20. In other words, if the Tg of the thermoplastic polymeric material exiting the extrusion head 18 is 280° C., then the device is capable of heating the area 56 to 260° C.-280° C., specifically 270° C. to 280° C. or 260° C. to 275° C. Some examples of possible energy sources include a light source (e.g., an ultraviolet light source, infrared light source, laser), heated inert gas, heat plate, infrared heat, and combinations comprising at least one of the foregoing. For example, energy source 54 can be a YAG laser with a power range of about 20 Watts (W) to 200 with a wavelength of 1064 nanometers (nm). Possible inert gases depend upon the particular thermoplastic material, and include any gas that will not degrade or otherwise react with the thermoplastic material at the processing temperatures. Examples of possible inert gases include nitrogen, air, and argon.

Optionally, a temperature sensor 72 (e.g., a non-contact temperature sensor) can be included in the apparatus to determine the temperature of the top portion 51 of layer 50, adjacent to the area to being heated such that the temperature of the top portion 51 of the layer 50 can be determined before the application of the energy source. This will allow online adjustment of the intensity of the heat from energy source 54 based upon the actual temperature of the top portion 51 and the desired temperature of area 56.

In order to attain desired adhesion characteristics, and or other part characteristics, the energy source (e.g., the hot gas nozzle) and the extrusion head (e.g., melt-tip) can move in tandem until the part is complete.

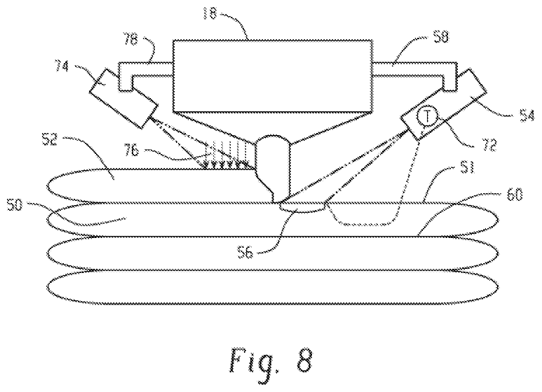

Also optionally included in the apparatus can be a pressure source 74 configured to apply a pressure to a layer after application of the thermoplastic material, e.g., adjacent to the extrusion head 18, so as to press the deposited thermoplastic material into the prior layer (e.g., to press layer 52 into layer 50), e.g., to densify the material, to remove gaps or air bubbles, and/or to enhance adhesion between the layers. (See FIG. 8)

Furthermore, as is well understood in material extrusion additive manufacturing, a step or valley is created between adjacent layers. This valley 80 between layers detracts from the aesthetics of the final product and is undesirable. (see FIG. 5) The valley has a depth from the base of the valley to the surface of the adjacent layers. Applying a pressure to the thermoplastic material after it has been applied, compacts the thermoplastic material, causing it to flow into the valley 80, reducing the size thereof. The application of pressure to the layer can reduce a depth of the valley by greater than or equal to 50%, specifically, greater than or equal to 70%, and even greater than or equal to 80%. For example, if the depth of the valley is 10 micrometers (μm) without the application of the pressure, the depth after the application of the pressure will be less than or equal to 5 μm.

The pressure applied can be that sufficient to perform at least one of the following: densify the layer, remove air bubbles, remove gaps between the applied and prior layer, and to allow the thermoplastic material to flow into the valley.

For example, the pressure source can be device capable of imparting a gas stream under (e.g., compressed gas) onto the layer. The process can be further modified to use the high-pressure gas stream to cause the just-deposited polymer melt to flow slightly up to the edges of the previously deposited layer just enough to fill up the corner portions between the two adjacent layers making the tapered surface smoother and thus improving the aesthetics and strength of the formed part. To ensure dimensional control, an additional amount of melt would need to be deposited corresponding to the amount of melt being made to flow fill in the corner portion for making the surface smoother.

Examples of suitable extrusion heads for use in system 10 can include those disclosed U.S. Pat. No. 7,625,200, which is incorporated by reference in its entirety. Furthermore, system 10 may include a plurality of extrusion heads 18 for depositing modeling and/or support materials from one or more tips. Thermoplastic material can be supplied to extrusion head 18 from supply source 20, thereby allowing extrusion head 18 to deposit the thermoplastic material to form article 24.

The thermoplastic materials may be provided to system 10 in an extrusion-based additive manufacturing system in a variety of different media. For example, the material can be supplied in the form of a continuous monofilament. For example, in system 10, the modeling materials can be provided as continuous monofilament strands fed respectively from supply source 20. Examples of suitable average diameters for the filament strands of the modeling and support materials range from about 1.27 millimeters (about 0.050 inches) to about 3.0 millimeters (about 0.120 inches). The received support materials are then deposited onto build platform 14 to build article 24 using a layer-based additive manufacturing technique. A support structure can also be deposited to provide vertical support for optional overhanging regions of the layers of article 24, allowing article 24 to be built with a variety of geometries.

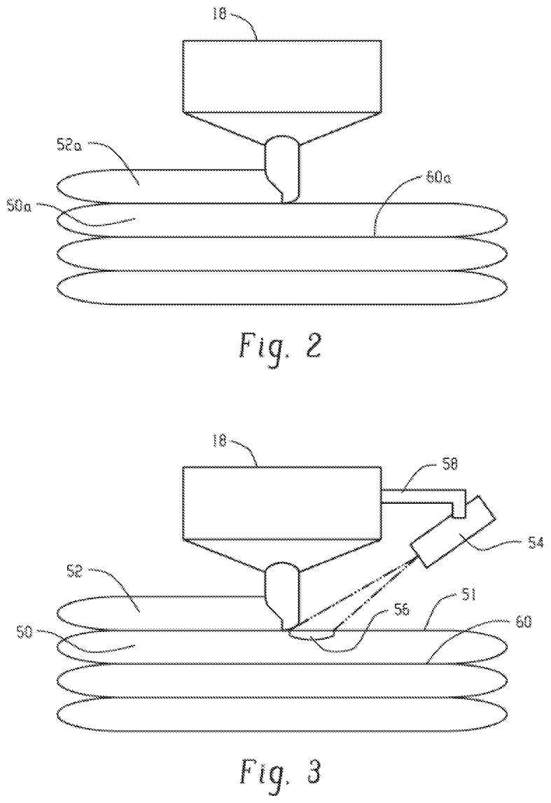

As shown in FIG. 2, a 3D model can be made using an extrusion head 18 without an accompanying energy source 54. Using this technique, extrusion head 18 deposits a layer 50a onto platform 14. Layer 50a is allowed to harden, and subsequent layer 52a is deposited on top of layer 50a. A surface contact area 60a is defined between layer 50a and subsequent layer 52a. The process is repeated until the article 24 is complete.

As shown in FIG. 3, an energy source 54 is coupled to extrusion head 18 via support arm 58. In operation, the extrusion head 18 of FIG. 3 deposits a layer 50 onto platform 14. Prior to depositing subsequent layer 52, energy source 54 directs energy to energy source target area 56. The choice of laser wavelength depends on the absorption of the composition and the interaction between the substrate, and the laser can be manipulated by modifying the laser parameters such as power, frequency, speed, focus, and the like. The interaction between the laser and the substrate can also be tuned or improved by the addition of additives that absorb the wavelength of the laser. An excimer laser can be used for ultraviolet wavelengths (e.g., 120-450 nm). A diode laser can be used for wavelengths in the visible spectrum (e.g., 400-800 nm). And solid state or fiber lasers can be used for wavelengths in the near-infrared region (e.g., 800-2100 nm). For example, depending on the laser wavelength, specific additives can be used to achieve an effective balance between properties and interaction. Non-limiting exemplary additives can include 2-(2 hydroxy-5-t-octylphenyl) benzotriazole for ultraviolet wavelengths, carbon black for visible spectrum wavelengths, and lanthanum hexaboride for near-infrared wavelengths.

Energy source target area 56 can include a top portion 51 of layer 50 located in the area where subsequent layer 52 will be deposited. In other words, the energy source 54 can deliver energy to energy source target area 56 to increase the surface energy of a top portion 51 of deposited layer 50 before the depositing of layer 52 onto layer 50. Thus, energy source 54 increases the surface energy of at least a top portion 51 (also referred to as the portion of layer 50 where layer 52 will be deposited) of layer 50 at energy source target area 56 prior to the depositing of layer 52, which results in an increase in the bonding strength between the two layers. This improved bond strength results from a lowering energy discrepancy between layer 50 and layer 52. The higher temperature of layer 52 allows improved molecular entanglement between surfaces enabling greater cohesion. A lower temperature discrepancy between the layers limits stress at the interface due to disproportional shrinkage. In addition, the increase of surface energy of the top portion 51 of layer 50 can allow for the surface contact area 60 between layers 50 and 52 to be increased over surface the contact area 60a (FIG. 2) where no energy source is employed. Energy source target area 56 can include greater than or equal to about 50% of the width of the layer 50. Energy source target area 56 can include less than or equal to about 50% of the width of the layer 30.

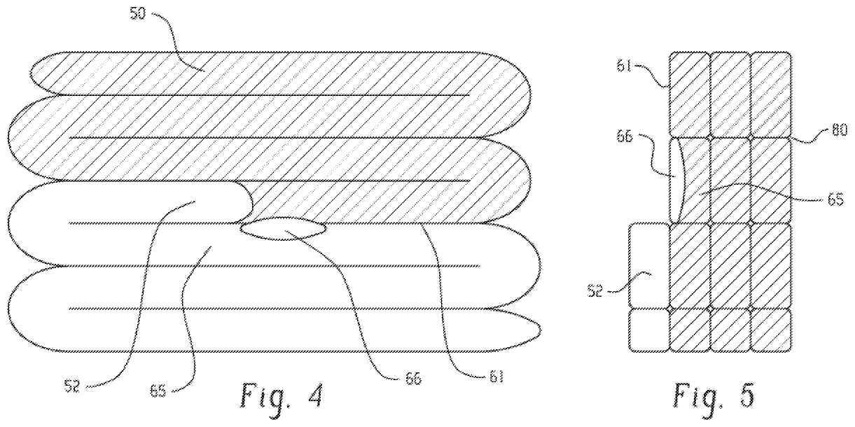

As shown in FIGS. 4 and 5, energy source target area 66 can include a side portion 61 of layer 65 located adjacent to the area where subsequent layer 52 will be deposited. In other words, the energy source 54 can deliver energy to energy source target area 66 to increase the surface energy of a side portion 61 of deposited layer 60 before the depositing of layer 52 adjacent to layer 65. Thus, energy source 54 increases the surface energy of at least a side portion 61 of layer 65 at energy source target area 66 prior to the depositing of layer 52, which results in an increase in the bonding strength between the two layers. This improved bond strength results from a lowering energy discrepancy between layer 65 and layer 52. The higher temperature of layer 52 allows improved molecular entanglement between surfaces enabling greater cohesion. A lower temperature discrepancy between the layers limits stress at the interface due to disproportional shrinkage.

The use of energy source 54 to increase the surface energy of target area 56 can also allow for a reduction in porosity in the final article 24. For example, a product made through this process can have 30% less porosity than a product made through an additive manufacturing process that does not employ energy source 54. In addition, the layer to layer adhesion could improve up to about 50%, as measured in accordance with ASTM D-3039.

In one embodiment, the energy source 54 only applies energy to the energy source target area on the portion of the layer 50 that comes into contact and then adheres to other subsequent layers. In that embodiment, it does not directly apply energy to the other portions of the layer 50. In other embodiments, the energy may be transferred to other portions of the layer. The time between the application of the energy source 54 to the energy source target area 56 and the contacting of the sequential layer is relatively short so as to not allow the applied energy to dissipate from the layer. In some embodiments, this time period would be less than one minute, specifically, less than 0.5 minutes, and even less than 0.25 minutes.

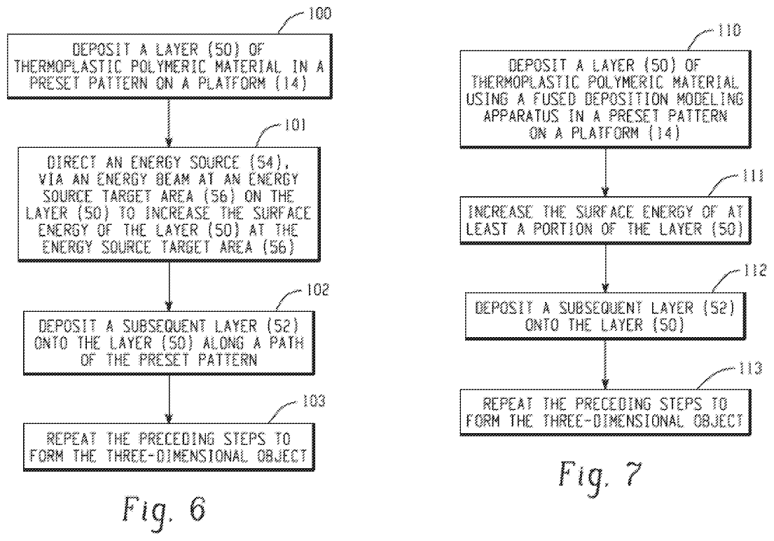

FIG. 6 depicts a method of making three dimensional article 24. A layer 50 of thermoplastic polymeric material is deposited in a preset pattern on a platform 14 in Step 100. Next, an energy source 54 is directed via an energy beam at energy source target area 56 on layer 50 to increase the surface energy of layer 50 at energy source target area 56 in Step 101. Subsequent layer 52 is deposited on layer 50 along the path of the preset pattern in Step 102. Steps 100-102 are repeated to form three dimensional article 24.

FIG. 7 illustrates another method for forming three dimensional article 24. In step 110, layer 50 of thermoplastic polymeric material is deposited using a fused deposition modeling apparatus in a preset pattern on platform 14. The surface energy of at least a portion of layer 50 is increased in Step 111. Subsequent layer 52 is deposited onto layer 50 in Step 112. Steps 110-112 are repeated to form three dimensional article 24.

A reduction in porosity, increased bond strength between adjacent layers, and increased surface contact between adjacent layers can improve the aesthetic quality of 3D article 24. In addition, additional post process steps such as sanding, curing, and/or additional finishing can be reduced. Accordingly, an increase in production rate and product quality can be attained in using the system and methods described herein.

### Embodiment 1

A method of forming a three dimensional object comprising: depositing a layer of thermoplastic polymeric material in a preset pattern on a platform to form a deposited layer; directing an energy source, via an energy beam at an energy source target area on the deposited layer to increase the surface energy of the deposited layer at the energy source target area; contacting the energy source target area with a subsequent layer wherein the subsequent layer is deposited along a path of the preset pattern; wherein directing an energy source at the energy source target area comprises applying energy to the layer at an area preceding the depositing of the subsequent layer to that area; and repeating the preceding steps to form the three dimensional object.

### Embodiment 2

A method of forming a three dimensional object comprising: depositing a layer of thermoplastic material through a nozzle, using a fused deposition modeling apparatus in a preset pattern on a platform to form a deposited layer; increasing the surface energy of at least a portion of the deposited layer; depositing a subsequent layer onto the deposited layer on at least the portion comprising the increased surface energy; repeating the preceding steps to form the three dimensional object.

### Embodiment 3

The method of any of the preceding Embodiments, wherein increasing the surface energy comprises directing an energy source at an energy source target area on the deposited layer to increase the surface energy of the deposited layer at the energy source target area; wherein directing an energy source at the energy source target area comprises applying energy to the layer at an area preceding the depositing of the subsequent layer to that area.

### Embodiment 4

The method of any of the preceding Embodiments, further comprising sensing a temperature of the deposited layer prior to the increasing the surface energy, in an area where the surface energy will be increased, and increasing the surface energy based upon the sensed temperature.

### Embodiment 5

The method of any of the preceding Embodiments, wherein increasing the surface energy comprises at least one of: applying energy to a top surface of the deposited layer at an area preceding the depositing of the subsequent layer to that area of the top surface; and applying energy to a side surface of an adjacent deposited layer at an area preceding the depositing of the subsequent layer to that area of the side surface.

### Embodiment 6

The method of any of the preceding Embodiments, further comprising applying pressure to the subsequent layer adjacent to the nozzle.

### Embodiment 7

The method of any of the preceding Embodiments, wherein the layer comprises extruded strands.

### Embodiment 8

The method of any of the preceding Embodiments, wherein the energy source comprises an light source, heated plate, infrared heat, heated inert gas, and combinations comprising at least one of the foregoing.

### Embodiment 9

The method of any of the preceding Embodiments, wherein directing an energy source comprises at least one of: raising the temperature of the energy source target area to greater than the glass transition temperature of the thermoplastic polymeric material; raising the temperature of the energy source target area to a temperature (X) that is Y≥X≥Y−20; and raising the temperature of the energy source target area to a temperature between the glass transition temperature of the thermoplastic polymeric material and the melting temperature of the thermoplastic polymeric material.

### Embodiment 10

The method of Embodiment 9, wherein directing an energy source comprises raising the temperature (X), wherein the temperature (X) is Y≥X≥Y−10, preferably Y−5≥X≥Y−20.

### Embodiment 11

The method of any of the preceding Embodiments, wherein the surface contact area between layer and subsequent layer is greater than the surface contact area for layer and subsequent layer that does not include the step of directing an energy source at an energy source target area.

### Embodiment 12

The method of any of the preceding Embodiments, wherein the time period between the step of increasing the surface energy and the step of depositing the subsequent layer is less than one minute.

### Embodiment 13

The method of any of the preceding Embodiments, wherein directing an energy source at the energy source target area comprises applying energy to a top surface of the deposited layer at an area preceding the depositing of the subsequent layer to that area of the top surface.

### Embodiment 14

The method of any of the preceding Embodiments, wherein directing an energy source at the energy source target area comprises applying energy to a side surface of an adjacent deposited layer at an area preceding the depositing of the subsequent layer to that area of the side surface.

### Embodiment 15

The method of any of the preceding Embodiments, wherein the thermoplastic polymeric material comprises polycarbonate, acrylonitrile butadiene styrene, acrylic rubber, liquid crystal polymer, methacrylate styrene butadiene, polyacrylates, polyacrylonitrile, polyamide, polyamide-imide, polyaryletherketone, polybutadiene, polybutylene, polybutylene terephthalate, polycaprolactone, polyethylene terephthalate, polycyclohexylene dimethylene terephthalate, polyhydroxyalkanoates, polyketone, polyesters, polyester carbonates, polyethylene, polyetheretherketone polyetherketoneketone, polyetherimide, polyethersulfone, polysulfone, polyimide, polylactic acid, polymethylpentene, polyolefins, polyphenylene oxide, polyphenylene sulfide, polyphthalamide, polypropylene, polystyrene, polysulfone, polyphenylsulfone, polytrimethylene terephthalate, polyurethane, styrene-acrylonitrile, silicone polycarbonate copolymers, or any combination comprising at least one of the foregoing.

### Embodiment 16

The method of any of the preceding Embodiments, wherein the thermoplastic polymeric material comprises polycarbonate.

### Embodiment 17

The method of any of the preceding Embodiments, wherein the energy source comprises an ultraviolet light source, infrared light source, laser, heated plate, infrared heat, and combinations comprising at least one of the foregoing.

### Embodiment 18

The method of any of the preceding Embodiments, wherein the energy source is a laser.

### Embodiment 19

The method of any of the preceding Embodiments, wherein directing an energy source comprises raising the temperature of the energy source target area greater than the glass transition temperature of the thermoplastic polymeric material.

### Embodiment 20

The method of any of the preceding Embodiments, wherein the energy source target area comprises greater than or equal to about 30% of the width of the layer.

### Embodiment 21

The method of any of the preceding Embodiments, wherein the energy source target area comprises less than or equal to about 30% of the width of the layer.

### Embodiment 22

The method of any of the preceding Embodiments, wherein directing an energy source comprises raising the temperature of the energy source target area to a temperature between the glass transition temperature of the thermoplastic polymeric material and the melting temperature of the thermoplastic polymeric material.

### Embodiment 23

The method of any of the preceding Embodiments, wherein the layers are deposited from an extrusion head.

### Embodiment 24

The method of Embodiment 23, wherein the vertical distance between the extrusion head and the layer is increased prior to depositing a subsequent layer.

### Embodiment 25

The method of Embodiment 24, wherein increasing the vertical distance comprises lowering the platform.

### Embodiment 26

The method of Embodiment 24, wherein increasing the vertical distance comprises raising the extrusion head.

### Embodiment 27

The method of any of the preceding Embodiments, wherein the three dimensional object comprises a porosity 30% less than a product made through an additive manufacturing process that does not employ energy source.

### Embodiment 28

The method of any of the preceding Embodiments, wherein the surface contact area between layer and subsequent layer is greater than the surface contact area for layer and subsequent layer that does not include the step of directing an energy source at an energy source target area.

### Embodiment 29

The method of any of the preceding Embodiments, wherein increasing the vertical distance comprises at least one of: lowering the platform; and raising the extrusion head.

### Embodiment 30

The method of any of the preceding Embodiments, wherein the surface energy of the layer is increased only in that portion of the layer that is the surface area target area.

### Embodiment 31

The method of any of the preceding Embodiments, wherein the time period between the step of increasing the surface energy of at least a portion of the layer and the step of depositing a subsequent layer is less than one minute.

### Embodiment 32

The method of any of the preceding Embodiments, wherein the subsequent layer is deposited on the portion of layer having the increased surface energy.

### Embodiment 33

The method of any of the preceding Embodiments, wherein area having the increased surface energy is less than or equal to 10% an area of the surface of layer.

### Embodiment 34

The method of any of the preceding Embodiments, wherein area having the increased surface energy is less than or equal to 5% an area of the surface of layer.

### Embodiment 35

The method of any of the preceding Embodiments, wherein area having the increased surface energy is less than or equal to 2% an area of the surface of layer.

### Embodiment 36

An apparatus for forming a three dimensional object comprising: a platform configured to support the three-dimensional object; an extrusion head arranged relative to the platform and configured to deposit a thermoplastic material in a preset pattern to form a layer of the three-dimensional object; an energy source disposed relative to the extrusion head and configured to increase the surface energy of an energy source target area; wherein the energy source target area comprises a portion of a deposited layer preceding the area for the depositing of a subsequent layer; a controller configured to control the position of the extrusion head and the energy source relative to the platform.

### Embodiment 37

The apparatus of Embodiment 36, further comprising a temperature sensor capable of sensing a temperature of the deposited layer prior to the increasing the surface energy, in an area where the surface energy will be increased, and increasing the surface energy based upon the sensed temperature.

### Embodiment 38

The apparatus of any of Embodiments 36-37, further comprising a pressure sensor capable of applying pressure to the subsequent layer adjacent to the nozzle.

### Embodiment 39

The apparatus of any of Embodiments 36-38, wherein the energy source comprises an light source, heated plate, infrared heat, heated inert gas, and combinations comprising at least one of the foregoing.

### Embodiment 40

The apparatus of any of Embodiments 36-39, wherein the energy source target area comprises a top portion of the deposited layer.

### Embodiment 41

The apparatus of any of Embodiments 36-40, wherein the energy source target area comprises a side portion of the deposited layer.

### Embodiment 42

The apparatus of any of Embodiments 36-41, wherein energy source is coupled to extrusion head via support arm.

### Embodiment 43

The apparatus of any of Embodiments 36-42, wherein energy source is not coupled to extrusion head.

### Embodiment 44

The apparatus of any of Embodiments 36-43, wherein the energy source target area comprises greater than or equal to about 50% of the width of the layer.

### Embodiment 45

The apparatus of any of Embodiments 36-44, wherein the energy source target area comprises less than or equal to about 50% of the width of the layer.

### Embodiment 46

The apparatus of any of Embodiments 36-45, wherein the thermoplastic polymeric material comprises polycarbonate, acrylonitrile butadiene styrene, acrylic rubber, liquid crystal polymer, methacrylate styrene butadiene, polyacrylates (acrylic), polyacrylonitrile, polyamide, polyamide-imide, polyaryletherketone, polybutadiene, polybutylene, polybutylene terephthalate, polycaprolactone, polyethylene terephthalate, polycyclohexylene dimethylene terephthalate, polyhydroxyalkanoates, polyketone, polyesters, polyester carbonates, polyethylene, polyetheretherketone, polyetherketoneketone, polyetherimide, polyethersulfone, polysulfone, polyimide, polylactic acid, polymethylpentene, polyolefins, polyphenylene oxide, polyphenylene sulfide, polyphthalamide, polypropylene, polystyrene, polysulfone, polyphenylsulfone, polytrimethylene terephthalate, polyurethane, styrene-acrylonitrile, silicone polycarbonate copolymers, or any combination comprising at least one of the foregoing.

### Embodiment 47

The apparatus of any of Embodiments 36-46, wherein the thermoplastic polymeric material comprises polycarbonate.

### Embodiment 48

The apparatus of any of Embodiments 36-47, wherein the controller is configured to modify the vertical distance between the extrusion head and the layer prior to depositing a subsequent layer.

### Embodiment 49

The apparatus of any of Embodiments 36-48, wherein the energy source is a laser.

### Embodiment 50

The apparatus of any of Embodiments 36-49, wherein the energy source is a heated inert gas.

### Embodiment 51

The apparatus of any of Embodiments 36-50, wherein a vertical distance between the platform and the extrusion head is adjustable.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or” unless clearly dictated otherwise by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. Unless specified otherwise herein, all test standards are the most recent test standard as of the filing date of the present application.

All references are incorporated herein by reference in their entirety.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. A method of forming a three dimensional object comprising:
depositing a layer of thermoplastic material through a nozzle, using a fused deposition modeling apparatus in a preset pattern on a platform to form a deposited layer;
increasing the surface energy of at least a portion of the deposited layer;
depositing a subsequent layer onto the deposited layer on at least the portion comprising the increased surface energy;
repeating the preceding steps to form the three dimensional object.

2. The method of claim 1, wherein increasing the surface energy comprises directing an energy source at an energy source target area on the deposited layer to increase the surface energy of the deposited layer at the energy source target area; wherein directing an energy source at the energy source target area comprises applying energy to the layer at an area preceding the depositing of the subsequent layer to that area.

3. The method of claim 2, wherein the energy source comprises an light source, heated plate, infrared heat, heated inert gas, and combinations comprising at least one of the foregoing.

4. The method of claim 1, further comprising sensing a temperature of the deposited layer prior to the increasing the surface energy, in an area where the surface energy will be increased, and increasing the surface energy based upon the sensed temperature.

5. The method of claim 1, wherein increasing the surface energy comprises at least one of
applying energy to a top surface of the deposited layer at an area preceding the depositing of the subsequent layer to that area of the top surface; and
applying energy to a side surface of an adjacent deposited layer at an area preceding the depositing of the subsequent layer to that area of the side surface.

6. The method of claim 5, comprising applying sufficient pressure in order to at least one of
densify the layer,
remove air bubbles,
remove gaps between the deposited layer and subsequent layer; and
allowing the thermoplastic material to flow into a valley located between the deposited layer and subsequent layer.

7. The method of claim 1, further comprising applying pressure to the subsequent layer adjacent to the nozzle.

8. The method of claim 1, wherein the layer comprises extruded strands.

9. The method of claim 1, wherein directing an energy source comprises raising the temperature of the energy source target area to greater than the glass transition temperature of the thermoplastic polymeric material.

10. The method of claim 9, further comprising increasing a vertical distance between the platform and the nozzle, wherein increasing the vertical distance comprises at least one of
lowering the platform;
raising the nozzle.

11. The method of claim 1, wherein the surface contact area between layer and subsequent layer is greater than the surface contact area for layer and subsequent layer that does not include the step of directing an energy source at an energy source target area.

12. The method of claim 1, wherein the time period between the step of increasing the surface energy and the step of depositing the subsequent layer is less than one minute.

13. The method of claim 1, wherein directing the energy source comprises raising the temperature of the energy source target area to a temperature between the glass transition temperature of the thermoplastic polymeric material and the melting temperature of the thermoplastic polymeric material.

14. A method of forming a three dimensional object comprising:
depositing a layer of thermoplastic material through a nozzle on to a platform to form a deposited layer;
depositing a subsequent layer onto the deposited layer;
applying pressure to the subsequent layer adjacent to the nozzle; and repeating the preceding steps to form the three dimensional object.

15. The method of claim 14, comprising applying sufficient pressure in order to at least one of
densify the layer,
remove air bubbles,
remove gaps between the deposited layer and subsequent layer; and
allowing the thermoplastic material to flow into a valley located between the deposited layer and subsequent layer.

16. A method of forming a three-dimensional object comprising:
depositing a layer of thermoplastic material through a nozzle in a preset pattern on a platform configured to support the three-dimensional to form a deposited layer;
increasing the surface energy of at least a portion of the deposited layer;
depositing a subsequent layer onto the deposited layer on at least the portion comprising the increased surface energy;
repeating the preceding steps to form the three-dimensional object; and
sensing a temperature of the deposited layer prior to increasing the surface energy, in an area where the surface energy will be increased, and increasing the surface energy based upon the sensed temperature by adjusting an intensity of heat from an energy source.

17. The method of claim 16, further comprising moving the energy source and the nozzle in tandem.

18. The method of claim 16, wherein increasing the surface energy comprises at least one of
directing the energy source at the energy source target area on the deposited layer to increase the surface energy of the deposited layer at the energy source target area; wherein directing the energy source at the energy source target area comprises applying energy to the layer at an area preceding the depositing of the subsequent layer to that area;
applying energy to a top surface of the deposited layer at an area preceding the depositing of the subsequent layer to that area of the top surface; and
applying energy to a side surface of an adjacent deposited layer at an area preceding the depositing of the subsequent layer to that area of the side surface.

19. The method of claim 16, further comprising applying sufficient pressure to the subsequent layer adjacent to the nozzle in order to at least one of
densify the layer,
remove air bubbles,
remove gaps between the deposited layer and subsequent layer; and
allow the thermoplastic material to flow into a valley located between the deposited layer and subsequent layer.

20. The method of claim 16, further comprising increasing a vertical distance between the platform and the nozzle, wherein increasing the vertical distance comprises at least one of
lowering the platform; and
raising the nozzle.
